(19) United States
(12) Patent Application Publication
(10) Pub. No.: US 2017/0113609 A1
(43) Pub. Date: Apr. 27, 2017

(54) VEHICLE INFORMATION TRANSMISSION DEVICE AND METHOD

(71) Applicant: Leauto Intelligent Technology (BEIJING) Co., Ltd., Beijing (CN)

(72) Inventors: Wenrui LI, Beijing (CN); Kunsheng CHEN, Beijing (CN); Yong XU, Beijing (CN); Wei LIN, Beijing (CN); Peng LIU, Beijing (CN)

(21) Appl. No.: 14/960,331

(22) Filed: Dec. 4, 2015

(30) Foreign Application Priority Data
Oct. 21, 2015 (CN) 201510694830.3

(51) Int. Cl. B60Q 9/00; H04W 4/00; G01S 19/17; H04L 29/08

(52) U.S. Cl. CPC B60Q 9/008; H04L 67/12; H04W 4/008; G01S 19/17

(57) ABSTRACT

The present disclosure provides vehicle information transmission device and method. A vehicle is provided with an OBU which including: a navigation module, configured to acquire vehicle driving information of a current vehicle; an information integration module, configured to receive vehicle warning information and generate integrated warning information according to the vehicle warning information and the vehicle driving information; a communication processor module, configured to package the integrated warning information in a default format; and a wireless transmission module, configured to transmit the packaged integrated warning information to other vehicles. In the embodiments of the present disclosure, since the vehicles transmit vehicle information via the OBU and all use a fixed communication protocol, there is no need to bring into communication connection in advance, thereby improving transmission efficiency of the vehicle information.

### TECHNICAL FIELD

The embodiments of the present disclosure relate to the field of intelligent transportation technologies and in particular to vehicle information device and method.

### BACKGROUND

Usually, special vehicles are necessary to undertake some special services, for example, when dealing with an emergency, rescuing and maintaining national or public security. On the premise of ensuring safety, the special vehicles are not restricted by driving route, driving direction, driving speed and signal lamp and other vehicles and walkers should avoid them. Therefore, for the special vehicles, it is the fundamental guarantee in a race against time that front vehicles in the lane give way in time to keep the road clear.

Warning forms of existing special vehicles mainly include an alarm, a marker lamp and the like. These caution forms have a limited propagation distance and are inclined to be influenced due to shelter, visibility and environmental noise. Mostly, there is no time for the front vehicles to give way such that the special vehicle has to slow down or change lane and thereby the precious rescuing time is wasted.

### SUMMARY

The embodiments of the present disclosure provides a vehicle information transmission device and method, to solve the problem that there is no time for the front vehicles to give way such that the special vehicle has to slow down or change lane when an alarm or a marker lamp is used for caution in the prior art.

The embodiment of the present disclosure provides a vehicle information transmission device, wherein a vehicle is provided with an OBU which including:

a navigation module, configured to acquire vehicle driving information of a current vehicle:

an information integration module, configured to receive vehicle warning information and generate integrated warning information according to the vehicle warning information and the vehicle driving information;

a communication processor module, configured to package the integrated warning information in a default format; and

a wireless transmission module, configured to transmit the packaged integrated warning information to other vehicles.

The embodiment of the present disclosure provides a vehicle information transmission method, wherein a vehicle is provided with an OBU by which the vehicle is able to communicate with one another and the method includes steps of:

obtaining vehicle driving information of a cu t vehicle;

receiving vehicle warning information, and generating integrated warning information according to the vehicle warning information and the vehicle driving information;

packaging the integrated warning information in a default format; and

transmitting the packaged integrated warning information to other vehicles.

The embodiments of the present disclosure provide vehicle information transmission device and method, when there is a need for a vehicle to transmit data to other vehicles, the OBU mounted in the vehicle can be used to set, up a wireless communication; the obtained vehicle driving information and vehicle warning information can be first integrated into integrated warning information and then packaged as transmittable integrated warning f the OBU in order to be transmitted to other vehicles. Since the vehicles in the embodiment of the present disclosure transmit vehicle information via the OBU and all use a fixed communication protocol to set up communications, there is no need to bring into communication connection in advance, thereby improving transmission efficiency of the vehicle information.

The embodiments of the present disclosure are applicable to special vehicles. Since the embodiments of the present disclosure provide a stable, long-distance-transmission-of-information and smart warning device for special vehicle avoidance, when the special vehicle is travelling, it is possible to transmit data to other vehicles on roads via the OBU mounted in the special vehicles, thereby overcoming shortages that warning tools such as alarm, marker lamp and the like have a short warning distance and are easily influenced by environment. Therefore, front vehicles can instantly receive vehicle information, such that they may have sufficient time to give way, no as to keep the road unblocked.

### BRIEF DESCRIPTION OF THE DRAWINGS

In order to more apparently describe the technical schemes in the embodiments of the present disclosure or in the prior art, accompanying figures necessarily used in the description of the embodiments or the prior art will be simply explained hereinafter. Obviously, the accompanying figures described below will form the embodiments of the present disclosure. An ordinary person skilled in the on may conceive further figures in accordance with these accompanying figures without contributing creative labor.

FIG. 1 is a block diagram showing an example of a vehicle information transmission device according to an embodiment of the present disclosure; and

FIG. 2 is a flow chart showing an example of a vehicle information transmission method according to an embodiment of the present disclosure.

### DETAILED DESCRIPTION

In order that objectives, technical schemes and advantages of the embodiments of the present disclosure become more apparent, the technical schemes in the embodiments of the present disclosure will be thoroughly and completely described below in conjunction with the accompanying figures in the embodiments of the present disclosure. It is obvious that the embodiments described herein are some of embodiments of the present disclosure rather than entire embodiments. On the basis of the embodiments of the present disclosure, other embodiments conceived by an ordinary person skilled in the art without creative labor would fall into the scope of the present disclosure.

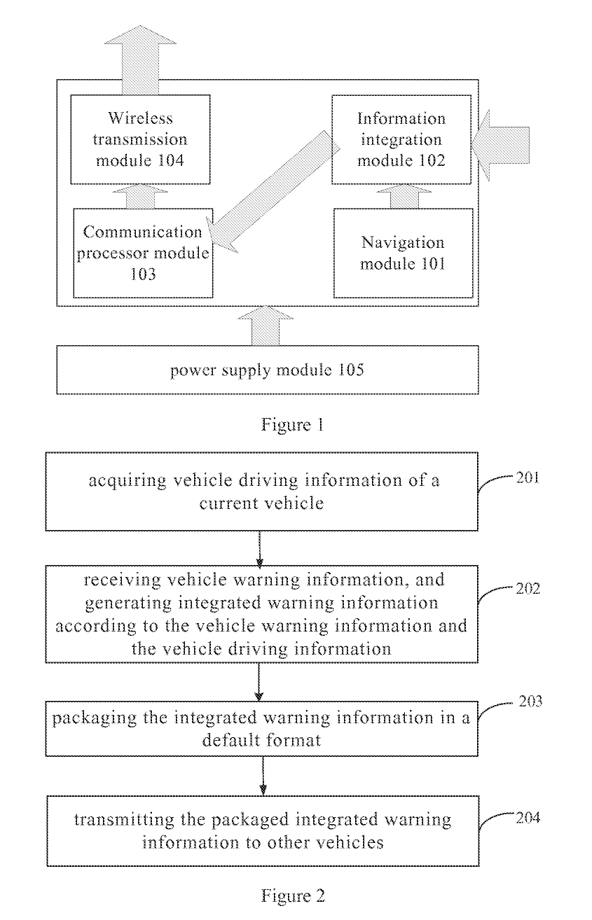

With reference to FIG. 1, it shows a block diagram of an example of a vehicle information transmission device according to an embodiment of the present disclosure. The vehicle in the embodiment of the present disclosure can be provided with an OBU (On board Unit).

It should be explained that the OBU in the embodiment of the present disclosure is a microwave device which is mounted in the vehicle and which is able to be communicated with another OBU in a vehicle or another apparatus established on roadside by using DSRC (Dedicated Short Range Communication). For example, in ETC (Electronic Toll Collection), the OBU is mounted in the vehicle to mutually communicate with a RSU (Road Side Unit) established on roadside through microwave such that functions of identifying vehicle and electronically deducting, for example, can be completed.

The DSRC, as a highly-efficient wireless communication technology, can achieve the identification and the two-way communication (for example, “vehicle-road” and “vehicle-vehicle” two-way communication of the vehicle) of an object moving at high speed within a specific small area (usually, tens of meters), so as to real-time transmit images, voice and data information to complete an organized connection between the roads and the vehicles. In a practical application, the establishment of the connection between the vehicles and roads can real-time provide an optimized driving route according to the road condition, in order to alleviate traffic pressure; and the establishment of the connection between the vehicles can remind of a safe distance from a vehicle to one another to early warn an accident occurred on the road ahead and to improve the transportation safety factor. By applying the DSRC to the intelligent transportation, the efficiency of people's transportation can be continuously perfected and improved.

Of course, the embodiments of the present disclosure are not merely limited to the use of the DSRC to transmit the information of vehicle, but various communication protocols can be selected according to actual situations and demands and should not be restricted by the embodiments of the present disclosure.

In an embodiment of the present disclosure, the OBU (On board Unit) mounted in the vehicle may particularly include: a navigation module 101, an information integration module 102, a communication processor module 103 and a wireless transmission module 104. Detailed functions of the modules are described as follows.

The navigation module 101 is configured to acquire vehicle driving information of a current vehicle.

In a preferred embodiment of the present disclosure, the navigation module 101 may include a following sub-module:

a vehicle driving information acquisition sub-module, configured to acquire location information, speed information, route information and/or destination information of the c t vehicle by a GPS (Global Positioning System), a GNSS (Global Navigation Satellite System), a G-sensor (Gravity-sensor) and/or a CAN (Controller Area Network).

Other than the commonly-used route navigation, the navigation module 101 according to the embodiment of the present disclosure is mostly used for acquiring information such as current location, speed, route and destination of the vehicle.

In a preferred example of the present disclosure, the GPS (Global Positioning System) or the GNSS (Global Navigation Satellite System) can be used to locate the vehicle to acquire the current location of the vehicle.

In a preferred example of the present disclosure, the G-sensor (Gravity-sensor) can be used to acquire the current speed of the vehicle. The G-sensor is able to perceive changes in an accelerating force. The accelerating force is a force that is applied to an object when the object is accelerated. Various movement changes, such as waggle, decline, ascent and descent, can be converted to electrical signals by the G-sensor. After the computation and the analysis of a microprocessor, information as necessary, such as the current speed of the vehicle, can be acquired.

In a preferred example of the present disclosure, the destination location can be set or input by a user. Further information such as the destination location set input by a user can be read by the CAN (Controller Area Network) of the vehicle, which is one of the most widely-applied field buses at present.

It should be explained that the acquisition method of the vehicle driving information in the embodiment of the present disclosure include but are not limited to the methods of utilizing the GPS/GNSS and the g-sensor and reading from the CAN bus of the vehicle. Further, the acquisition or the transmission of data can be completed through cloud servers. For example, the cloud servers can be used to acquire and also to transmit vehicle driving data, which is not restricted by the embodiment of the present disclosure.

The information integration module 102 is configured to receive vehicle warning information and generate integrated warning information according to the vehicle warning information and the vehicle driving information;

In an embodied implementation, the information integration module is mainly used to integrate the warning information. The information integration module can integrate input information to generate the integrated warning information, in particular, the input information in the information integration module may contain two parts. One part of input information can be set by a user input, such as a voice input or a manual input. For example, the user may input some information “Fire occurs in XX community, please turn to right and give way to left lane” as caution language. The other part of input information can be provided by the navigation module, at least including the current location, speed, route and destination information of the vehicle therein.

After the input information is all integrated by the information integration module to generate the integrated warning information, the integrated warning information may be output to the communication processor module for the next processing.

The communication processor module 103 is configured to package the integrated warning information in a default format.

In a preferred embodiment of the present disclosure, the OBU may support the DSRC, and the communication processor module 103 may include a following sub-module:

a DSRC data packaging sub-module, configured to package the integrated warning information in conformity with the DSRC.

In the embodiment of the present disclosure, the integrated warning information is packaged by the communication processor module to convert warning contents into data information, in order to conform to requirements of the wireless transmission module.

In a preferred example of the present disclosure, the integrated warning information can be packaged according to technical specifications of the DSRC, the packaging process can strictly follow a data format specified by the DSRC and be completed by a protocol stack of the DSRC.

In brief, source data (for example, the integrated integration warning data) can be subject to a series of format conversion (i.e., packaging), and in the format conversion, a header and a trailer with fixed format, in which specific positions contain specific meanings, specified by the DSRC protocol can be added. For example, a certain bit of a byte can represent a function enable bit, wherein “0” represents function is enabled and “1” represents function is disabled. Finally, transmittable messages can be generated and transmitted by hardware (for example, the wireless transmission module in the embodiment of the present disclosure).

The wireless transmission module 104 is configured to transmit the packaged integrated warning information to other vehicles.

In a preferred embodiment of the present disclosure, the wireless transmission module 104 may include a following sub-module:

an integrated warning information transmitting sub-module, configured to transmit the packaged integrated warning information to other vehicles supporting DSRC in conformity with description of the DSRC.

In an embodied implementation, the wireless transmission module may include parts such as a RF (Radio Frequency) transmitting chip and a transmitting antenna. The wireless transmission module may support DSRC, have a wireless communication range of up to 1000 m in open environment and up to 300 m in urban intensive environment, and not be influenced by blind angle, visibility and ambient noise in the radiation range.

In the embodiment of the present disclosure, when receiving the integrated warning information packaged according to the DSRC, the wireless transmission module can periodically transmit the integrated warning information by using the DSRC to other vehicle supporting the DSRC.

In a preferred embodiment of the present disclosure, the device may further include a following module:

a power supply module 105, configured to supply power to the navigation module, the information integration module, the communication processor module and the wireless transmission module, wherein the power is supplied by a rechargeable battery and/or a vehicle power adapter.

In an embodied implementation, the power supply module may further include some components such as a rechargeable battery, wires, a switch, a connector and a transformer. The power supply module is used to provide the OBU with necessary energy for operating.

In a preferred example of the present disclosure, the integrated warning information may also be transmitted to the RSU or other units established on the roadside. Over a specific period of time, if a vehicle passes by the RSU or other units established on the roadside, the RSU or other units established on the roadside may send warning information to the vehicle, reminding that a vehicle ahead is needed to give way; in the case that there is no emergency, the driver may appropriately slow down or change the lane.

With the embodiment of the present disclosure, when there is a need for a vehicle to transmit data to other vehicles, the OBU mounted in the vehicle can be used to set up a wireless communication; the obtained vehicle driving information and vehicle warning information can be first integrated into integrated warning information and then packaged as transmittable integrated warning information via the OBU in order to be transmitted to other vehicles. Since the vehicles in the embodiment of the present disclosure transmit vehicle information via the OBU and all use a fixed communication protocol (for example, DSRC) to set up communications, there is no need to bring into communication connection in advance, thereby improving transmission efficiency of the vehicle information.

The embodiment of the present disclosure is applicable to special vehicles undertaking special services, such as fire truck, ambulance, police car, machine shop truck and military supervision vehicle. When a special vehicle is running, the data can be transmitted to other vehicles on the road via OBU of the special vehicle, thereby overcoming shortages that warning tools such as alarm, marker lamp and the like have a short warning distance and are easily influenced by environment. Therefore, other vehicles can instantly receive the vehicle information, so that they could have enough time to take actions like avoidance, thereby keeping the road unblocked.

As it could be seen from above, the embodiment of the present disclosure is applicable to travelling vehicles; the applied vehicles may be considered as a mobile information transmission apparatus, which is able to real-time transmit road condition to other vehicles when travelling such that other vehicles can instantly take action to adjust driving route according to the road condition.

Under the current tendency, DSRC will be a popular protocol applied between vehicles. Research shows that injury and death rate of traffic accidents can be reduced by 90% when the DSRC is applied to the fields in relation to vehicle safety. In the future, vehicles could be forcefully required to mount OBU supporting DSRC or other on-board device by laws or regulations. Thus, the application of the vehicle information transmission device according to the embodiment of the present disclosure could better inform other vehicles of information such as emergent avoidance and good prospect.

With reference to FIG. 2, it shows a flow chart showing an example of vehicle information transmission according to an embodiment of the present disclosure. A vehicle is provided with an OBU by which the vehicle can communicate with one another. The vehicle information transmission method may particularly include steps of:

Step 201, obtaining vehicle driving information of a current vehicle.

In a preferred embodiment of the present disclosure, Step 201 may include a sub-step of:

acquiring location information, speed information, route information and or destination information of the current vehicle by a GPS (Global Positioning System), a GNSS (Global Navigation Satellite System), a G-sensor (Gravity-sensor) and/or a CAN (Controller Area Network).

Step 202, receiving vehicle warning information, and generating integrated warning information according to the vehicle warning information and the vehicle driving information.

Step 203, packaging the integrated warning information in a default format.

In a preferred embodiment of the present disclosure, the OBU can support DSRC, and Step 203 may include a step of:

packaging the integrated warning information in conformity with the DSRC.

Step 204, transmitting the packaged integrated warning information to other vehicles.

In a preferred embodiment of the present disclosure, Step 204 may include a sub-step of:

transmitting the packaged integrated warning information to other vehicles supporting DSRC in conformity with description of the DSRC.

In a preferred embodiment of the present disclosure, the method may further include a sub-step of:

supplying power to the OBU by using a rechargeable battery and/or a vehicle power adapter.

In order to better understand the embodiments of the present disclosure by those skilled in the art, hereinafter the embodiments of the present disclosure will be illustrated by way of a specific example. It should be explained that the example is merely an exemplary illustration of the embodiment of the present disclosure and should not be interpreted as a limiting of the embodiment of the present disclosure.

With reference to FIG. 1, the embodiment of the present disclosure may include the navigation module 101, the information integration module 102, the communication processor module 103, the wireless transmission module 104 and the power supply module 105. Detailed processes of completing the transmission of the vehicle information according to the embodiment of the present disclosure are as follows:

Step S1: the power supply module is used to supply power to other modules in the vehicle, including but not limited to a rechargeable battery, a vehicle power adapter and the like;

Step S2: the navigation module obtains location, speed, route and destination of the vehicle by means of reading signal data and destination set by a user from a vehicle CAN bus via the GPS/GNSS and the g-sensor, and transmits the information the information integration module in a specific data format;

Step S3: warning information for reminding other vehicles can be input by, including but not limited to, typing and voice by the use

Step S4: the information obtained at Step S2 and Step S3 is integrated by the information integration module and output as complete warning information to be processed by the communication processor module;

Step S5: the communication processor module converts the warning information into data information by packaging and transmits it to the wireless transmission module;

Step S6: the wireless transmission module can periodically emit the converted warning information in a form of radio waves in accordance with DSRC specifications such that nearby vehicles provided with OBU supporting he DSRC can receive the warning information and remind the driver; if a vehicle is right in a lane where a special vehicle is travelling, the driver may have enough time to take actions to give way in advance.

With the embodiments of the present disclosure, it is possible to instantly transmit the vehicle information to other vehicles, thereby overcoming shortages that warning tools such as alarm, marker lamp and the like in the prior art have a short warning distance and are easily influenced by environment. Therefore, e is provided a stable, long-distance-transmission-of-information and smart warning device for special vehicle avoidance, such that front vehicles may have sufficient time to give way, so as to keep the road unblocked.

Since the method embodiment in relation to FIG. 2 is substantially similar to the device embodiment as described, the description thereof is relatively simple. For the method embodiment, reference can be made to related parts of the device embodiment.

The above embodiment of client or server is described merely for a schematic purpose, wherein the units explained as individual members may or may not be physically separated, the members shown as units may or may not be physical units and they can be placed at a position or also can be distributed to network units. As necessary in practice, some or all of the modules can be selected to complete the objectives of the schemes of the embodiments. An ordinary person skilled in the art may understand and implement the embodiments without contributing creative labor.

Through above description of the implementations, it is obvious for the skilled in the art that the implementations can be completed by means of software in connection with necessary universal hardware platform or of course by means of hardware. Based on this understanding, the essence of aforesaid technical schemes or the part contributing to the prior art can be embodied in a form of software product. The computer software product can be stored in computer readable storage medium, such as ROM/RAM, magnetic disc, compact disc and the like, which contains a plurality of instructions such that a computing device (such as, personal computer, server or network apparatus) is able to execute the methods as described in the embodiments or a portion of the embodiment.

In the end, it should be explained that aforesaid embodiments are provided for the purpose of illustrating not limiting the technical schemes of the present disclosure. Although the present disclosure has been described in detail with reference to the embodiments, it should be understood that modifications or equivalent substitutions can be made to the technical schemes or some of technical features therein as disclosed in the embodiments by those skilled in the art; the modifications or substitutions will not bring the essence of the respective technical schemes to depart from spirit and scope of the technical schemes of the inventive embodiments.

1. A vehicle information transmission device, wherein, a vehicle is provided with an on board unit (OBU) which comprises:
a navigation module, configured to acquire vehicle driving information of a current vehicle;
an information integration module, configured to receive vehicle warning information and generate integrated warning information according to the vehicle warning information and the vehicle driving information;
a communication processor module, configured to package the integrated warning information in a default format; and
a wireless transmission module, configured to transmit the packaged integrated warning information to other vehicles.

2. The device according to claim 1, wherein, the device further comprises:
a power supply module, configured to supply power to the navigation module, the information integration module, the communication processor module and the wireless transmission module, wherein the power is supplied by a rechargeable battery or a vehicle power adapter.

3. The device according to claim 1, wherein, the navigation module comprises:
a vehicle driving information acquisition sub-module, configured to acquire location information, speed information, route information or destination information of the current vehicle by a global positioning system (GPS), a global navigation satellite system (GNSS), a gravity-sensor (G-sensor) or a controller area network (CAN).

4. The device according to claim 1, wherein, the OBU supports dedicated short range communication (DSRC), the communication processor module comprises:
a DSRC data packaging sub-module, configured to package the integrated warning information in conformity with the DSRC.

5. The device according to claim 1, wherein, the wireless transmission module comprises:
an integrated warning information transmitting sub-module, configured to transmit the packaged integrated warning information to other vehicles supporting DSRC in conformity with description of the DSRC.

6. A vehicle information transmission method, wherein, a vehicle is provided with an OBU by which the vehicle is able to communicate with one another and the method comprises steps of:
obtaining vehicle driving information of a current vehicle;
receiving vehicle warning information, and generating integrated warning information according to the vehicle warning information and the vehicle driving information;
packaging the integrated warning information in a default format; and
transmitting the packaged integrated warning information to other vehicles.

7. The method according to claim 6, wherein, the method further comprises:
supplying power to the OBU by using a rechargeable battery or a vehicle power adapter.

8. The method according to claim 6, wherein, the step of obtaining vehicle driving information of a current vehicle comprises:
acquiring location information, speed information, route information or destination information of the current vehicle by a GPS, a GNSS, a G-sensor or a CAN.

9. The method according to claim 6, wherein, the OBU supports DSRC, and the step of packaging the integrated warning information in a default format comprises:
packaging the integrated warning information in conformity with the DSRC.

10. The method according to claim 6, wherein, the step of transmitting the packaged integrated warning information to other vehicles comprises:
transmitting the packaged integrated warning information to other vehicles supporting DSRC in conformity with description of the DSRC.

11. The device according to claim 1, wherein, the device further comprises:
a power supply module, configured to supply power to the navigation module, the information integration module, the communication processor module and the wireless transmission module, wherein the power is supplied by a rechargeable battery and a vehicle power adapter.

12. The device according to claim 1, wherein, the navigation module comprises:
a vehicle driving information acquisition sub-module, configured to acquire location information, speed information, route information and destination information of the current vehicle by a GPS, a GNSS, a G-sensor and a CAN.

13. The device according to claim 2, wherein, the wireless transmission module comprises:
an integrated warning information transmitting sub-module, configured to transmit the packaged integrated warning information to other vehicles supporting DSRC in conformity with description of the DSRC.

14. The device according to claim 3, wherein, the wireless transmission module comprises:
an integrated warning information transmitting sub-module, configured to transmit the packaged integrated warning information to other vehicles supporting DSRC in conformity with description of the DSRC.

15. The device according to claim 4, wherein, the wireless transmission module comprises:
an integrated warning information transmitting sub-module, configured to transmit the packaged integrated warning information to other vehicles supporting DSRC in conformity with description of the DSRC.

16. The method according to claim 6, wherein, the method further comprises:
supplying power to the OBU by using a rechargeable battery and a vehicle power adapter.

17. The method according to claim 6, wherein, the step of obtaining vehicle driving information of a current vehicle comprises:
acquiring location information, speed information, route information and destination information of the current vehicle by a GPS, a GNSS, a G-sensor and a CAN.

18. The method according to claim 12, wherein, the step of transmitting the packaged integrated warning information to other vehicles comprises:
transmitting the packaged integrated warning information to other vehicles supporting DSRC in conformity with description of the DSRC.

19. The method according to claim 14, wherein, the step of transmitting the packaged integrated warning information to other vehicles comprises:
transmitting the packaged integrated warning information to other vehicles supporting DSRC in conformity with description of the DSRC.

20. The method according to claim 16, wherein, the step of transmitting the packaged integrated warning information to other vehicles comprises:
transmitting the packaged integrated warning information to other vehicles supporting DSRC in conformity with description of the DSRC.
